(19) United States
(12) Patent Application Publication
(10) Pub. No.: US 2006/0033994 A1
(43) Pub. Date: Feb. 16, 2006

(54) Thin brightness enhancement polarizer

(75) Inventors: Tung-Lung Li, Pin Chen City (TW); Chen-Yung Chang, Pin Chen City (TW); Long-Hai Wu, Pin Chen City (TW)

Correspondence Address: BRUCE H. TROXELL;SUITE 1404, 5205 LEESBURG PIKE, FALLS CHURCH, VA, 22041, US

(73) Assignee: Optimax Technology Corporation

(21) Appl. No.: 10/965,881

(22) Filed: Oct. 18, 2004

(30) Foreign Application Priority Data
Aug. 10, 2004 (TW) 93123851

(51) Int. Cl. G02B 5/30

(52) U.S. Cl. 359/494; 359/483

(57) ABSTRACT

It is the primary object of the invention to provide an ultra-thin brightness enhancement polarizer, and as the result, reduce the overall thickness of a display screen employing the brightness enhancement polarizer. In order to achieve the aforementioned object, the present invention provides a brightness enhancement polarizer, comprising: a reflective film, having a first surface and a second surface, for reflecting a portion of light incident thereon; a hydrophilic retardation film, having a first surface and a second surface, for modulating the phase of the light incident thereon; and a polarizing plate, having a first surface and a second surface, for modulating the polarity of the light incident thereon; wherein, the first surface of the retardation film is attached onto the second surface of the reflective film, and the first surface of the polarizing plate is attached onto the second surface of the retardation film.

### 1. FIELD OF THE INVENTION

The present invention relates to a brightness enhancement polarizer, and more particularly, to a brightness enhancement polarizer with reduce thickness.

### 2. BACKGROUND OF THE INVENTION

Since most of the current portable electronic devices, such as notebook computer (NB), person digital assistant (PDA), and mobile phone, etc., generally use liquid crystal display (LCD) as their display screen whose light source is not an active illuminant but a backlight module, the displaying quality of those passive screen is thus dependent on the brightness revealed on the same.

For instance, in addition to increase the illuminating power of the backlight module of an LCD, a brightness enhancement polarizer can be used by attaching itself onto the LCD for enhancing the brightness of the LCD. Please refer to FIG. 1, which is a schematic illustration showing a convention brightness enhancement polarizer. As seen in FIG. 1, the surface of the layer of liquid crystal cell 100 facing toward the backlight module 110 is attached with a plural layer of films successively, where the outer most film is a layer of cholesteric liquid crystal (CLC) 120. Through the cholesteric layer 120, the light radiating from the backlight module 110 can be reflected back to the backlight module 110 such that the light emitted by the backlight module 110 can be recycled for increasing the amount of light incident to the layer of liquid crystal cell 100. Therefore, the layer of cholesteric liquid crystal 120 is usually referred as the brightness enhancement film.

Moreover, a quarter-wave plate 130 and a polarizing plate of polyvinyl alcohol (PVA) 140 both being arranged between the cell 100 and the cholesteric layer 120 are respectively being used for modulating the phase and polarity of the light emitted from the backlight module 100 so as to enrich and beautify the general appearance of a picture revealed on the cell layer 100. As for the layer of triacetyl cellulose (TAC) 150, it is being used for supporting the polarizing plate 140. In addition, the layer of triacetyl cellulose (TAC) 135 arranged between the polarizing plate 140 and the quarter-wave plate 130 is used for enabling the quarter-wave plate 130 to adhere on the TAC so that the quarter-wave plate 130 is substantially adhered onto the polarizing plate 140 in an indirect manner, since the material characteristics of the quarter-wave plate 130 prohibit the same from being attached directly on the polarizing plate 140.

Since the recent tendency for designing a mobile electronic device is the smaller and lighter the better, the thickness of the display screen used in a mobile electronic device is required to be thinner accordingly. In this regard, how to employ the brightness enhancement polarizer and the other multi-function films to increase the brightness of the display screen, enrich and beautify the general appearance of the picture revealed on the display screen, and the same time, reduce the thickness of the brightness enhancement polarizer and the other multi-function films to meet with the design requirements, has become a focus point for further research.

In view of the above description, the present invention provides a brightness enhancement polarizer and the method of making the same, which is capable of decreasing the amount of structures composing the brightness enhancement polarizer so as to reduce the thickness of the display screen consisting the brightness enhancement polarizer.

### SUMMARY OF THE INVENTION

It is the primary object of the invention to provide an ultra-thin brightness enhancement polarizer, and as the result, reduce the overall thickness of a display screen employing the brightness enhancement polarizer. In order to achieve the aforementioned object, the present invention provides a brightness enhancement polarizer, comprising:
a reflective film, having a first surface and a second surface, for reflecting a portion of light incident thereon;
a hydrophilic retardation film, having a first surface and a second surface, for modulating the phase of the light incident thereon; and
a polarizing plate, having a first surface and a second surface, for modulating the polarity of the light incident thereon;
wherein, the first surface of the retardation film is attached onto the second surface of the reflective film, and the first surface of the polarizing plate is attached onto the second surface of the retardation film.

In a preferred embodiment of the invention, the reflective film is substantially a layer of cholesteric liquid crystal, and the retardation film is substantially a quarter-wave plate. In addition, the brightness enhancement polarizer further comprises a transparent plastic plate as the supporting for the polarizing plate of the invention.

Moreover, the hydrophilic retardation film used in the invention can be replaced with a non-hydrophilic retardation film such that the retardation film is adhered onto the polarizing plate by a hydrophilic glue.

The fabrication method, using a hydrophilic glue to make a brightness enhancement polarizer of the invention, includes the step of:
providing a polarizing plate;
using a hydrophilic glue to adhere the polarizing plate onto a retardation film; and
wet-coating a layer of cholesteric liquid crystal on the surface of retardation film opposite to the surface of the same attaching to the polarizing plate.

### BRIEF DESCRIPTION OF THE DRAWINGS

FIG. 1 is a schematic illustration showing a convention brightness enhancement polarizer.

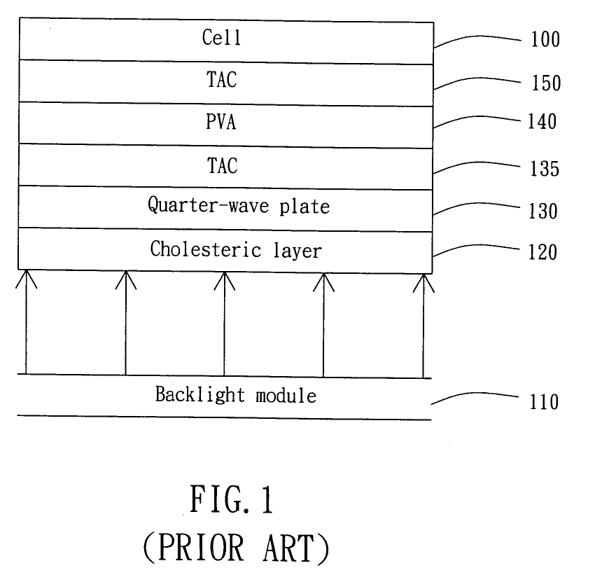

FIG. 2 is a schematic illustration showing a brightness enhancement polarize according to a preferred embodiment of the present invention.

FIG. 3 is a flowchart depicting the method for making the brightness enhancement polarize of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

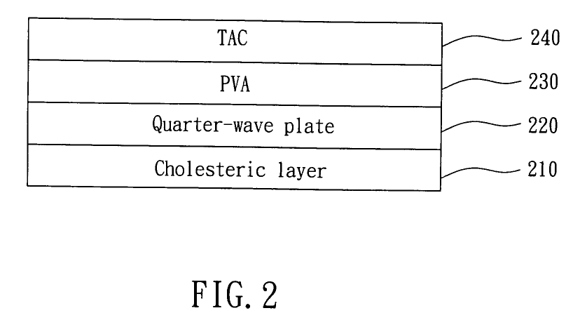

Please refer to FIG. 2, which is a schematic illustration showing a brightness enhancement polarize according to a preferred embodiment of the present invention. The brightness enhancement polarize 200 of FIG. 2 comprises: a layer of cholesteric liquid crystal (CLC) 210 for using the same as a reflective film; a hydrophilic quarter-wave plate 220 for using the same as a retardation film; a polarizing plate 230; and a layer of triacetyl cellulose (TAC) 240 for using the same to support the polarizing plate 230.

For enabling the quarter-wave plate 220 to adhere directly onto the polarizing plate 230 without by way of a layer of transparent plastic, such as TAC, the brightness enhancement polarize of the invention employs a quarter-wave plate with hydrophilic characteristic for enabling the quarter-wave plate 220 to adhere onto the polarizing plate 230 directly since the polarizing plate 230 itself is hydrophilic. In this regard, the brightness enhancement polarize of the invention is a plastic plate thinner then a conventional brightness enhancement polarize.

Since the plastic plate used in the conventional brightness enhancement polarize can have a thickness of about 80 μm, the overall thickness of the brightness enhancement polarize of the invention is reduced by 80 μm.

In addition, since the structure of the brightness enhancement polarize of the invention is a layer of plastic plate less than a conventional polarizer, the light transmission of the invention is improved and thus can has a better brightness enhancing effect.

Therefore, a display screen using the brightness enhancement polarize of the invention not only is thinner, but also can show a higher brightness.

Following the concept of invention, except for attaching a hydrophilic retardation film directly onto a polarizing plate, a hydrophilic glue can be used for attaching a non-hydrophilic retardation film directly onto a polarizing plate.

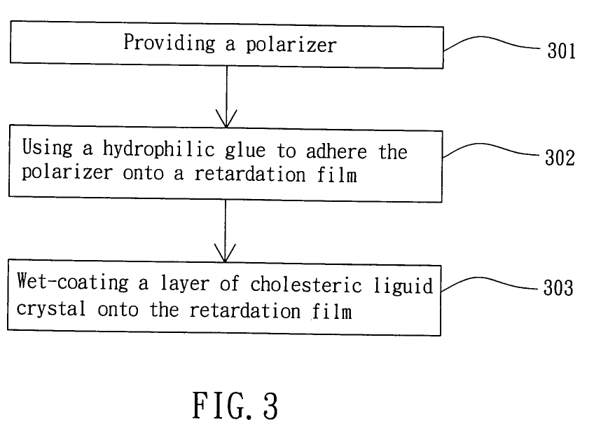

Please refer to FIG. 3, which is a flowchart depicting the method for making the brightness enhancement polarize of the present invention. The fabrication method, using a hydrophilic glue to make a brightness enhancement polarizer of the invention, includes the step of:
step 301: providing a polarizing plate;
step 302: coating a hydrophilic glue on a retardation film for enabling the retardation film to adhere onto the polarizing plate; and
step 303: wet-coating a layer of cholesteric liquid crystal on the surface of retardation film opposite to the surface of the same attaching to the polarizing plate.

The advantages of the invention are as following:
(a) Since the retardation film of the invention can be attached directly onto the polarizing plate, the shortcoming that a layer of TAC is require for a conventional retardation film to adhere onto a polarizing plate by way of the same. Therefore, the brightness enhancement polarizer of the invention is thinner than the convention one and is much more appearing for any modern design.
(b) Since the brightness enhancement polarizer of the invention is a layer of TAC less than the convention brightness enhancement polarizer, not only the overall thickness of the brightness enhancement polarizer is reduce, but also the light transmission is improved.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A brightness enhancement polarizer, comprising:
a reflective film, having a first surface and a second surface, for reflecting a portion of light incident thereon;
a hydrophilic retardation film, having a first surface and a second surface, for modulating the phase of the light incident thereon; and
a polarizing plate, having a first surface and a second surface, for modulating the polarity of the light incident thereon;
wherein, the first surface of the retardation film is attached onto the second surface of the reflective film, and the first surface of the polarizing plate is attached onto the second surface of the retardation film.

2. The brightness enhancement polarizer as claimed in claim 1, wherein the reflective film is a layer of cholesteric liquid crystal.

3. The brightness enhancement polarizer as claimed in claim 1, wherein the brightness enhancement polarizer further comprise:
a transparent plastic plate, having a first surface adhering to the second surface of the polarizing plate and a second surface.

4. The brightness enhancement polarizer as claimed in claim 3, wherein the transparent plastic plate is a layer of triacetyl cellulose.

5. The brightness enhancement polarizer as claimed in claim 1, wherein the retardation film is substantially a film selected from the group consisting of a quarter-wave plate (Nx>Ny=Nz) and a biaxial film(Nx>Ny>Nz).

6. A brightness enhancement polarizer, comprising:
a reflective film, having a first surface and a second surface, for reflecting a portion of light incident thereon;
a retardation film, having a first surface and a second surface, for modulating the phase of the light incident thereon; and
a polarizing plate, having a first surface and a second surface, for modulating the polarity of the light incident thereon;
wherein, the first surface of the retardation film is attached onto the second surface of the reflective film by a hydrophilic glue, and the first surface of the polarizing plate is attached onto the second surface of the retardation film.

7. The brightness enhancement polarizer as claimed in claim 6, wherein the reflective film is a layer of cholesteric liquid crystal.

8. The brightness enhancement polarizer as claimed in claim 6, wherein the brightness enhancement polarizer further comprise:
a transparent plastic plate, having a first surface adhering to the second surface of the polarizing plate and a second surface.

9. The brightness enhancement polarizer as claimed in claim 8, wherein the transparent plastic plate is a layer of triacetyl cellulose.

10. The brightness enhancement polarizer as claimed in claim 6, wherein the retardation film is substantially a film selected from the group consisting of a quarter-wave plate (Nx>Ny=Nz) and a biaxial film(Nx>Ny>Nz).

11. A fabrication method of brightness enhancement polarizer, comprising the steps of:
providing a polarizing plate;
using a hydrophilic glue to adhere the polarizing plate onto a retardation film; and
wet-coating a layer of cholesteric liquid crystal on the surface of retardation film opposite to the surface of the same attaching to the polarizing plate.

12. The fabrication method as claimed in claim 11, further comprising the step of:
coating the hydrophilic glue on the retardation film.
